(19) United States
(12) Patent Application Publication
(10) Pub. No.: US 2012/0038878 A1
(43) Pub. Date: Feb. 16, 2012

(54) Decorative Eyewear

(76) Inventor: Derrick Artips Echevarria, Jersey City, NJ (US)

(21) Appl. No.: 13/025,899

(22) Filed: Feb. 11, 2011

Related U.S. Application Data
(60) Provisional application No. 61/303,475, filed on Feb. 11, 2010.

(51) Int. Cl. G02C 11/02

(52) U.S. Cl. 351/51

(57) ABSTRACT

The design, styling, and decoration of eyewear can include attaching a decorative element to the lens of the eyewear. One or more decorative elements can be coupled to the lens in various ways including mechanically, magnetically, and chemically affixing the decorative element to the lens. The decorative element can be fixedly, rotatably, or detachably coupled to the lens. In certain configurations the eyewear can include multiple positioning elements for positioning the decorative element in various configurations.

### FIELD OF THE INVENTION

The present invention relates to fashion design, and more particularly to decorative design of eyewear.

### BACKGROUND

Eyewear design can include the design of glasses for vision correction, protection and/or comfort (e.g., sunglasses), and fashion. Eyewear is available in various shapes and sizes. Typical eyewear includes a lens, an eyewire (i.e., the part of the frame surrounding the lens), and a temple. Temples are manufactured in shapes including straight, bowed, skull (e.g., shaped like a hockey stick), and cable (e.g., a J-shaped wire that wraps around the ear). Temples are also available in various colors and widths. The eyewire is also available in various colors, materials (e.g., plastic, metallic, or wireless), thicknesses, and shapes (e.g., round, oval, rectangular, and aviator). Additionally, lenses are available in various tints and gradient of tints.

Eyewear, whether functional or a fashion statement, is selected and worn based on appearance and the wearer's sense of style. Accordingly, further developments and expansions in the design of eyewear are desirable.

### SUMMARY

In accordance with an embodiment of the present invention, eyewear can include a frame a lens and a decorative element coupled to the lens.

These and other advantages of the invention will be apparent to those of ordinary skill in the art by reference to the following detailed description and the accompanying drawings.

### BRIEF DESCRIPTION OF THE DRAWINGS

FIG. 1 is an illustration of eyewear in accordance with an embodiment of the present invention;

FIG. 2 is a an illustration of eyewear in accordance with an embodiment of the present invention;

FIG. 3A is an illustration of eyewear in accordance with an embodiment of the present invention;

FIG. 3B is an illustration of the eyewear of FIG. 3A configured in accordance with a further embodiment of the present invention;

FIG. 4A is an illustration of eyewear in accordance with an embodiment of the present invention; and

FIG. 4B is an illustration of the eyewear of FIG. 4A configured in accordance with a further embodiment of the present invention.

### DETAILED DESCRIPTION

While certain stylistic designs and accessories are known for the temples and eyewire of eyeglasses, little, aside from the tinting of lenses, is known with respect to the decorative and stylistic design of eyewear lenses. The present invention is generally directed to the design, styling, and decoration of such eyewear lenses by attaching decorative elements to the lens.

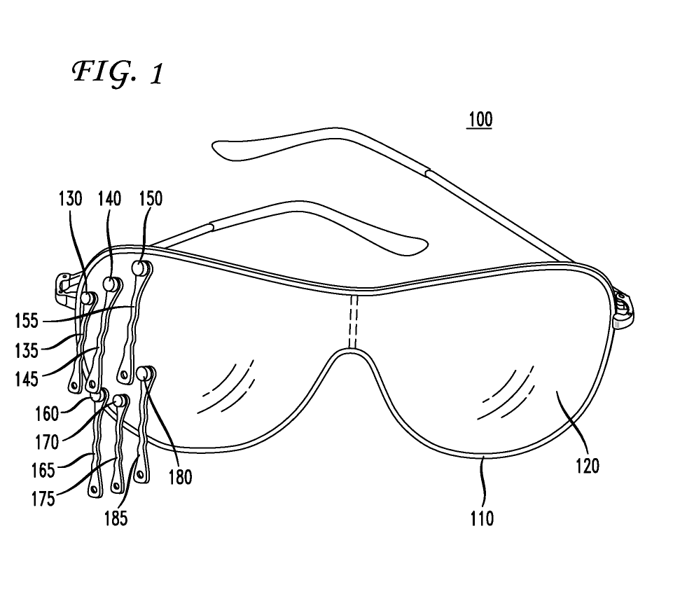

FIG. 1 illustrates eyewear 100 in accordance with an embodiment of the present invention. Eyewear 100 includes an eyewire 110 surrounding a lens 120. While eyewear 100 is illustrated having a single eyewire 110 forming a continuous perimeter around a single lens 120, in view of the description herein, one of ordinary skill in the art would understand that other styles of eyewire can be incorporated into an embodiment of the present invention, including for example round, rectangular, aviator, and frameless eyewear (i.e., eyewear having no eyewire). Lenses corresponding to the shape of the eyewire are available with various tints and corrective attributes including correction of myopia, hyperopia, astigmatism, and bi-focal or transitional lenses.

Eyewear 100 includes six mounts 130, 140, 150, 160, 170, and 180 coupled to the lens 120. Each mount 130, 140, 150, 160, 170, and 180 can by coupled to the lens chemically, such as by an adhesive or by fusion to the lens. Alternatively, mounts 130, 140, 150, 160, 170, and 180 can be coupled to the lens 120 by passing through holes in the lens. For example, a mount can include a nut and bolt, screw, rivet, pin, peg, or other known fastener. The mounts 130, 140, 150, 160, 170, and 180 can be arranged in a pattern on the lens 120 or placed randomly. As illustrated by FIG. 1, mounts 130, 140, and 150 are arranged in a diagonal line near the top of the lens, and mounts 160, 170, and 180 are arranged relatively randomly on the lower portion of lens 120. One of ordinary skill in the art would understand that other patterns and arrangements of mounts could be created on the lens using one or more mounts.

Attached to each mount 130, 140, 150, 160, 170, and 180 is a decorative element. Specifically, as illustrated with respect to eyewear 100, a link (i.e., chain link) 135 is attached to mount 130, a link 145 is attached to mount 140, a link 155 is attached to mount 150, a link 165 is attached to mount 160, a link 175 is attached to mount 170, and a link 185 is attached to mount 180. While certain decorative elements are illustrated in the Figures and described herein, a person of ordinary skill in the art would understand that other decorative elements and combinations of elements could be attached to the mounts of such decorative eyewear.

Certain mounts can be rotatably attached to the lens 120 such that the mount rotates with respect to the lens. For example a nut and mount type mount can rotate within a hole made through the lens 120. Alternatively, the mount can include a rotatable element top (e.g., cap or head) that can rotate with respect to a body of the mount coupled to the lens 120. By configuring the eyewear 100 with a rotatable mount, the decorative element attached to the mount (e.g., links 135, 145, 155, 165, 175, and 185) can rotate and move.

Furthermore, certain rotatable mounts can be held in specific positions, such that the decorative element can be positioned and maintained at specific angle. These specific angles can be maintained by friction or by mechanical stops (e.g., radial ridges or grooves, or an interlocking saw tooth pattern) in the mount.

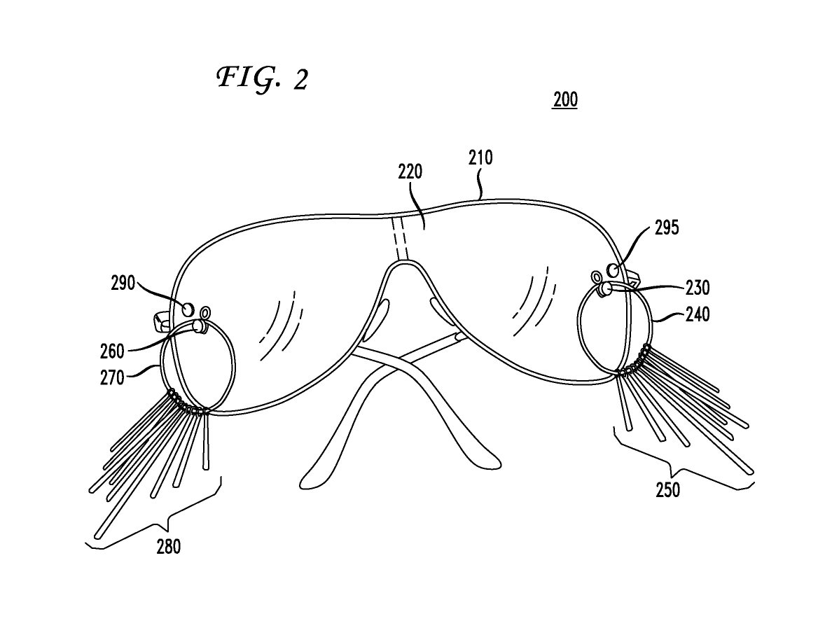

FIG. 2 is an illustration of eyewear 200 in accordance with a further embodiment of the present invention. As similarly discussed with respect to eyewear 100, eyewear 200 includes eyewire 210 and lens 220. Eyewear 200 includes mounts 230, 260, 290, and 295. Attached to mounts 230 and 260 are rings 240 and 270, respectively. Rings 240 and 270 are illustrated as fixedly attached to mounts 230 and 260. Alternatively, rings 240 and 260 could be coupled to mounts 230 and 260 by passing each ring through a hole in the mount. Attached to rings 240 and 270 are bars 250 and 280, respectively. Bars 250 and 280 are movable with respect to rings 240 and 270 because the bars 250 and 280 are loosely attached to rings 240 and 270 by passing each ring 240 and 270 through a hole in the bars 250 and 280 or by wrapping the bars 250 and 280 around the rings 240 and 270.

Decorative elements can be removed, added, or interchanged. As illustrated, eyewear 200 further includes mounts 290 and 295. No decorative elements are attached to mounts 290 and 295. However, if desired, decorative elements can be added using the available mounts 290 and 295. Additionally, rings 240 and 270, which are attached to mounts 230 and 260, could be interchanged with other decorative elements, such as those illustrated in FIGS. 1, 3A, 3B, and 4.

Interchangeability of decorative elements can also be provided by incorporating a magnet into the decorative element, the mount, or both. For example, mounts 290 and 295 can include a magnetic portion to which a decorative element could be attached. The decorative element can include either a ferromagnetic portion or a magnetic portion, which can be placed adjacent the magnetic mount such that the decorative element is attached to the mount. If the decorative element includes a magnetic portion, the mount can include a ferromagnetic portion or a magnetic portion. It should be noted that by using a magnetic mount rather than mechanical mount, the mount can be disposed on the inside of the lens (i.e., the surface of the lens nearest the wearer) or embedded in the lens such that if no decorative element is attached, a third party would not be aware the eyewear included a mount.

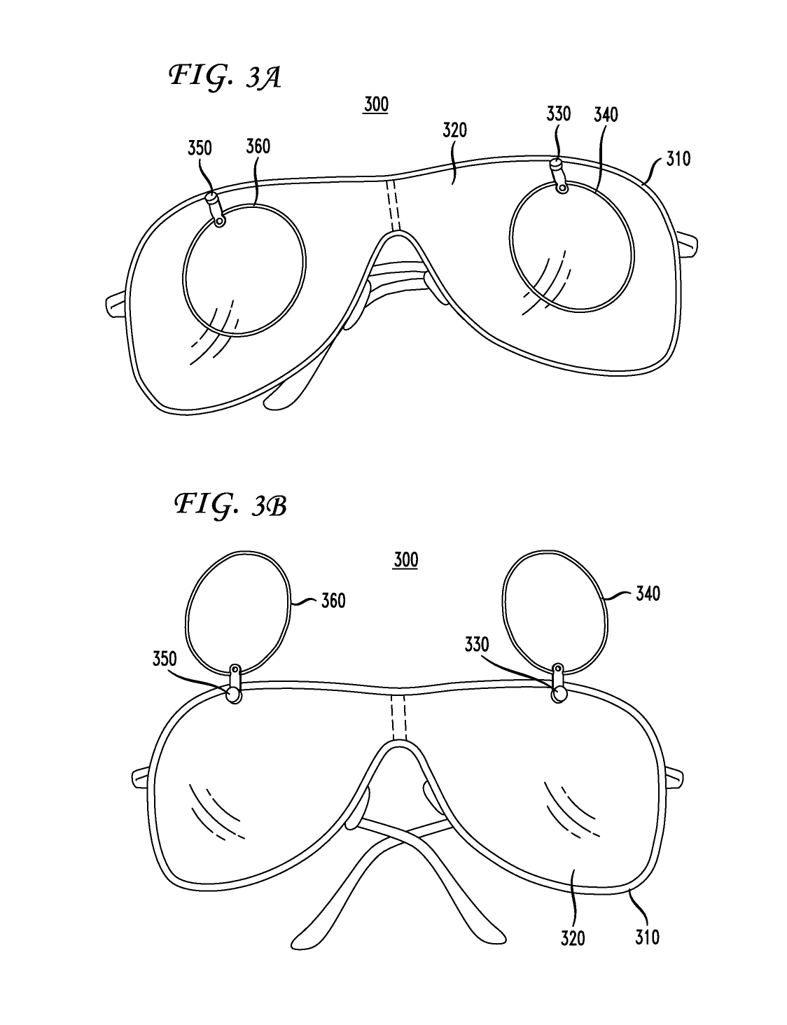

FIGS. 3A and 3B are illustrations of eyewear 300 in two configurations accordance with a further embodiment of the present invention. As similarly discussed with respect to eyewear 100, eyewear 300 includes eyewire 310 and lens 320. Attached to mount 330 is ring 340, and attached to mount 350 is ring 360.

FIG. 3A illustrates rings 340 and 360 rotated about mounts 330 and 350 such that the rings 340 and 360 are positioned over the front surface of lens 320. FIG. 3B illustrates rings 340 and 360 rotated about mounts 330 and 350 such that rings 340 and 360 are position away from the lens 320. While FIGS. 3A and 3B illustrate rings 340 and 360 as rotating about an axis substantially perpendicular to the front surface of lens 320, in an alternative, rings 340 and 360 could be configured to rotate about and axis substantially in a plane of the lens 320. That is, the rings 340 and 360 could pass through a hole in mounts 330 and 350 (e.g., a hole made radially through the mount) and rotated away from the lens 320 such that in an intermediate position, rings 340 and 360 are substantially perpendicular to the front surface of the lens 320, and as the rings 340 and 360 are further rotated about this axis, the rings 340 and 360 are moved into the position illustrated in FIG. 3B.

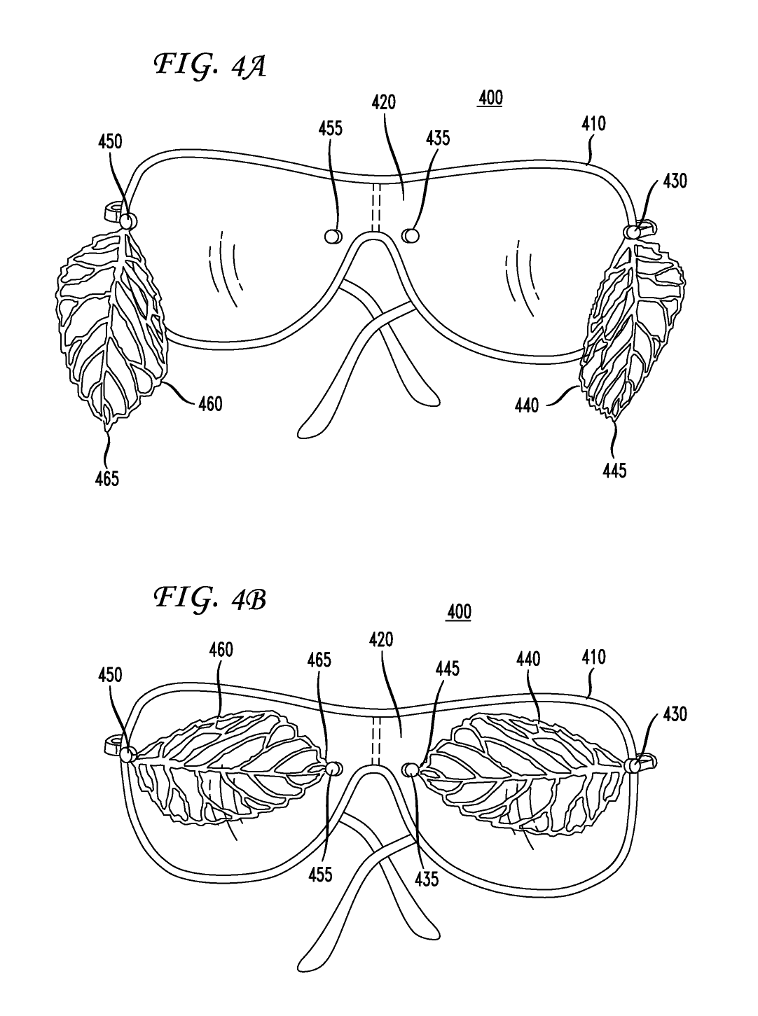

FIG. 4A is an illustration of eyewear 400 in accordance with an embodiment of the present invention. As similarly discussed with respect to eyewear 100, eyewear 400 includes eyewire 410 and lens 420. Mounts 430 and 450 are coupled to lens 420, and attached to mounts 430 and 450 are decorative elements 440 and 460. As discussed above, decorative elements 440 and 460 can be rotated about mounts 430 and 450. For example, decorative elements 440 and 460 can be rotated so as to be positioned in line with the front surface of the lens 420.

In accordance with one aspect of the present invention, the static friction between mount 430 and decorative element 440 and the static friction between mount 450 and decorative element 460 can be used to position the decorative elements 440 and 460 at various angles.

In yet a further aspect of the present invention, eyewear 400 can include positioning elements 435 and 455. These positioning elements 435 and 455 can be embedded in the lens 420, on the outer surface of the lens 420, on the inner surface of the lens 420, and/or through the lens 420. Positioning elements 435 and 455 can use magnetic forces to hold decorative elements 440 and 460 in specific orientations.

FIG. 4B illustrates eyewear 400 in a configuration where decorative elements 440 and 460 are rotated, relative to their orientation in FIG. 4A, approximately 90° about mounts 430 and 450, respectively. In this orientation, magnetically interactive portions 445 and 465 of decorative elements 440 and 460 are attracted to positioning elements 435 and 455 by magnetic forces, so as to maintain the orientation of decorative elements 440 and 460 as being inline with the lens 420, as shown in FIG. 4B. As illustrated, decorative elements 440 and 460 include open spaces within its structure so that even when positioned inline with the lens 420, a wearer of the eyewear 400 will be able to see through the lens 420 and the decorative elements 440 and 460.

As discussed above with respect to magnetic mounts, positioning elements 435 and 455 can include a magnet and/or magnetically interactive portions 445 and 465 can include a magnet. If positioning elements 435 and 455 include a magnet, magnetically interactive portions 445 and 465 can include a magnet or a ferromagnetic material. Alternatively, it magnetically interactive portions 445 and 465 include a magnet, positioning elements 435 and 455 can include a magnet or a ferromagnetic material.

It should be noted that the inclusion of magnets in positioning elements 435 and 455 and magnetically interactive portions 445 and 465 can be used to create additional configurations and motion effects and limitations of the decorative elements. For example, while illustrated as having two positioning elements 435 and 455 (i.e., one positioning element on each side of the eyewear 400) multiple positioning elements and differing numbers of positioning elements could be attached to lens 420 to provided for multiple, symmetrical and/or asymmetrical orientations of the decorative elements.

Additionally, if magnets are included in positioning elements 435 and 455 and magnetically interactive portions 445 and 465, rather than utilizing the attractive forces between opposite magnetic poles, the repelling forces created between common magnetic poles can be used to affect or control the movement of the decorative elements 440 and 460 as they move about mounts 430 and 450. That is for example, if dipole magnets in positioning element 435 and magnetically interactive portion 445 are oriented such that, when in the configuration of FIG. 4B, the same pole of each magnet is juxtaposed, then the magnetically interactive portion 445 will be repelled from the positioning element 435. In this manner, the movement of the decorative element 440 can be restricted and/or influenced such that the decoratively element is less likely to obstruct the wearer's vision as in the configuration illustrated in FIG. 4B. Thus, the magnetically interactive portions 445 and 465 and the positioning elements 435 and 455 can be placed in various locations to create varying influences and restrictions on the movement of decorative elements 440 and 460.

The foregoing Detailed Description is to be understood as being in every respect illustrative and exemplary, but not restrictive. It is to be further understood that the embodiments shown and described herein are only illustrative of the principles of the present invention and that various modifications may be implemented by those skilled in the art without departing from the scope and spirit of the invention. Those skilled in the art could implement various other feature combinations without departing from the scope and spirit of the invention. The various modules that are shown are for illustrative purposes only, and may be combined, rearranged and/or otherwise modified.

I claim:

1. Eyewear comprising:
a frame;
a lens; and
a decorative element coupled to the lens.
